(19) United States
(12) Patent Application Publication
(10) Pub. No.: US 2012/0090455 A1
(43) Pub. Date: Apr. 19, 2012

(54) Portable Ballistic Shelter System and Device

(76) Inventor: David Duncan, Ashburn, VA (US)

(21) Appl. No.: 13/273,905

(22) Filed: Oct. 14, 2011

Related U.S. Application Data
(63) Continuation-in-part of application No. 11/429,700, filed on May 8, 2006, now abandoned.

(51) Int. Cl. F41H 5/24; B32B 38/18; B32B 37/18

(52) U.S. Cl. 89/36.07; 156/60; 156/66; 156/93; 89/918

(57) ABSTRACT

A portable, lightweight ballistic panel integrated with a shelter is capable of withstanding penetration by ammunition and fragmentation, so that the occupants of the shelter remain safe and unharmed. In one embodiment of the invention, wall segments or panels of ballistic material are provided so as to hang from an interior or exterior frame member of the shelter. In another embodiment, the present invention provides a frame independent of the shelter frame to which the panels can be secured. The panels can be provided such that they fold up into portable and manageable units. In one embodiment of the invention, wall panels are provided with a welded seam that binds plies of the outer shell of the wall attachment with an inner ballistic-resistant material.

### REFERENCE TO RELATED APPLICATIONS

This application claims the benefit of U.S. provisional patent application Ser. No. 60/678,309, filed May 6, 2005 and entitled “Portable Ballistic Shelter System”, and is a continuation-in-part of U.S. application Ser. No. 11/429,700, filed May 8, 2006, and entitled “Portable Ballistic Shelter System and Device”, the disclosures of which are incorporated herein by reference.

### FIELD OF THE INVENTION

The present invention relates to shelters, and more particularly to portable armor provided in connection with portable shelters such as tents and soft-sided shelters, so as to provide shelters capable of withstanding various types of ammunition and fragmentation and thereby protect the occupants within.

### BACKGROUND OF THE INVENTION

Temporary Shelters such as tents can be provided with one or more layers of material forming the outer boundaries or walls of the structure. Such layers are generally penetrable by common ammunition and fragmentation or shrapnel. While such weaknesses are of little concern to a recreational camper, they become of grave concern to those engaged in activities within tents that are positioned in military zones and other hostile areas. Such tent or shelter deployments must necessarily he close to the hostile activities in order to provide individuals such as troops with proper medical attention, decontamination facilities, and the like; however, the standard shelter wall structure provides little to no protection to the shelter occupants.

### SUMMARY OF THE INVENTION

The present invention provides a portable, lightweight ballistic panel as part of a shelter capable of withstanding penetration by ammunition and fragmentation, so that the occupants of the shelter remain safe and unharmed. In one embodiment of the invention, wail segments or panels of ballistic material are provided so as to hang from an interior or exterior frame member of the shelter. The wall segments or panels can be formed with ballistic inserts and seams to permanently retain the inserts. In one embodiment, the seams can be formed by welding, in another embodiment, the present invention provides a frame independent of the shelter frame to which the panels can be secured. The panels can be provided such that they fold up into portable and manageable units.

### BRIEF DESCRIPTION OF THE DRAWINGS

FIG. 1 is a top right perspective view of a sample shelter structure in which the present invention can be deployed, with one end wall broken away.

FIG. 2 is a top right perspective view of the shelter of FIG. 1, with portions of the roof cut away to show interior features.

FIG. 3 is a right front perspective view of a series of adjoining tent structures in which the present invention can be deployed.

FIG. 4 shows a right side view of a portion of a wall structure in accordance with the present invention.

FIG. 5 shows a front view of an interior wall as outfitted in accordance with one embodiment of the present invention.

FIG. 6 shows a front view of an interior wall as outfitted in accordance with another embodiment of the present invention.

FIG. 7 is a schematic view of a wall attachment incorporating a seam in accordance with one embodiment of the present invention.

FIGS. 8 and 9 show schematic cross-sectional views of a wall attachment in accordance with different embodiments of the present invention.

### DETAILED DESCRIPTION OF THE PREFERRED EMBODIMENTS

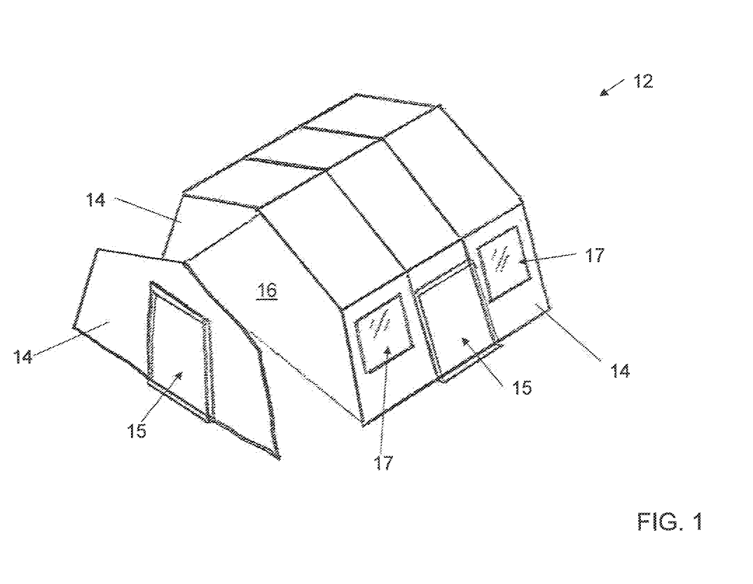

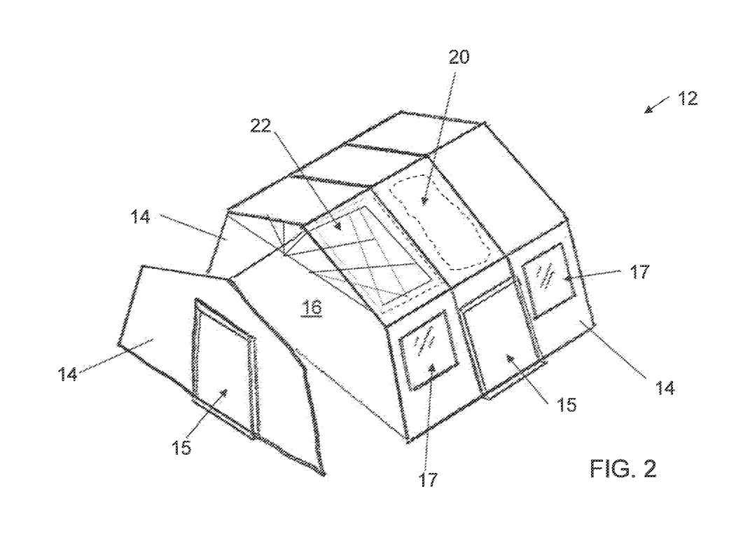

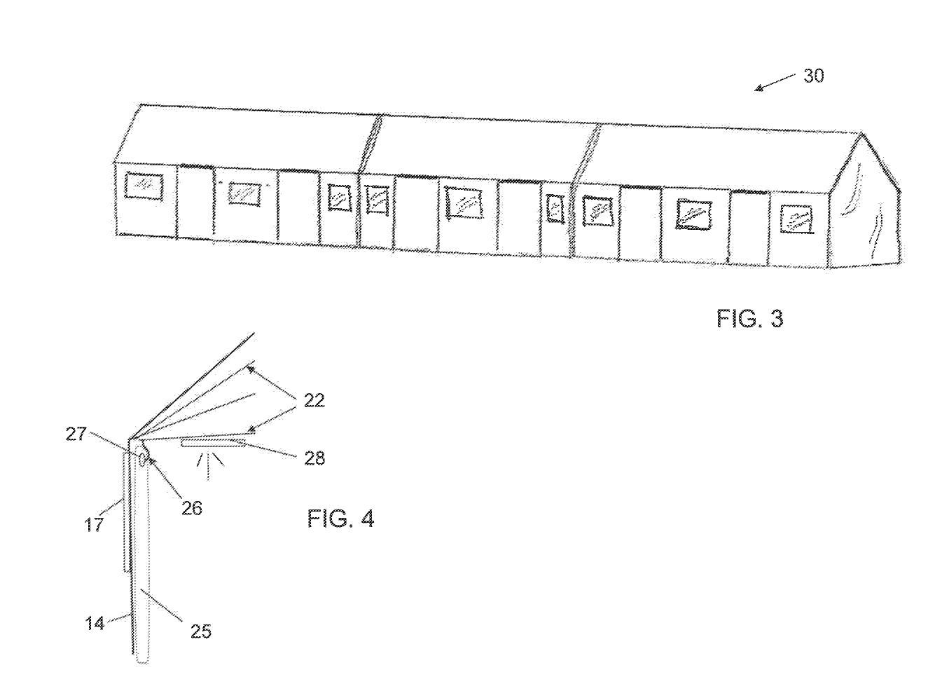

As shown in FIGS. 1 and 2, temporary shelters 12 such as tents can be provided with one or more layers of material forming the outer boundaries or walls 14 of the structure. In some cases, material also is provided to form a floor 16 covering the otherwise exposed ground within the tent or structure. Doors 15 and windows 17 are frequently provided as well. In some shelter systems, an outer layer or cover fabric 18 is employed along with an inner layer or liner fabric 20 to provide substantial protection from the elements as well as different physical invasive species (e.g., insects, chemical or biological weapons, etc.). These fabrics are portable and may be joined together in series to form a longer structure or complex, as shown at 30 in FIG. 3. Further, some shelters are provided with external or internal stabilizing frames 22 to facilitate the shelter build-out and strengthen the shelter frame.

FIG. 4 is a right side view of a portion of a wall structure in accordance with the present invention. As shown in FIG. 4, a wall 14 and window 17 are provided along with internal framework 22. A ballistic panel 25 can be suspended from the framework 22 such as by a hook member 26 secured to the framework and looped through an opening in the panel. The opening can be reinforced by a grommet 27, for example. In one embodiment of the invention, the hook members 26 can he slidably mounted to the framework so as to enable a customized fitting of the ballistic paneling. For example, if a portion of a shelter were barricaded behind a military vehicle or other large object, there may be no need for ballistic paneling for that portion, as any ammunition, fragmentation or other would-be penetrating element would need to first go through the vehicle before it reached the tent. In such examples, ballistic paneling may only be required for the remaining portion of the shelter not protected by the outside object (e.g., vehicle), in which case the hook members can be moved along the framework and positioned such that the paneling secured to the hook members appropriately covers the unprotected areas of the shelter. As further shown in FIG. 4, it will be appreciated that lighting 28 and other necessary internal objects can be positioned within the tent inside of the wall structure provided in accordance with the present invention to safely allow lighting or other functions within the tent, while not being exposed to projectiles, The hook members can optionally be clasp members, such as C-shaped metal clasps biased in the closed position and having a hinged portion which allows a user to open the otherwise closed clasp to receive a loop, grommet or eyelet, for example. In one embodiment of the invention, peg members are integrally formed with the frame or tent wall for receiving the loop, grommet or eyelet.

In one embodiment, a secondary frame separate and apart from the primary frame can be erected inside of the primary frame to provide a surface for mounting the panels or wall members. The secondary frame can be dimensioned so as to extend to the edges of the interior of the shelter generally defined by the wall members and somewhat defined by the primary frame where applicable.

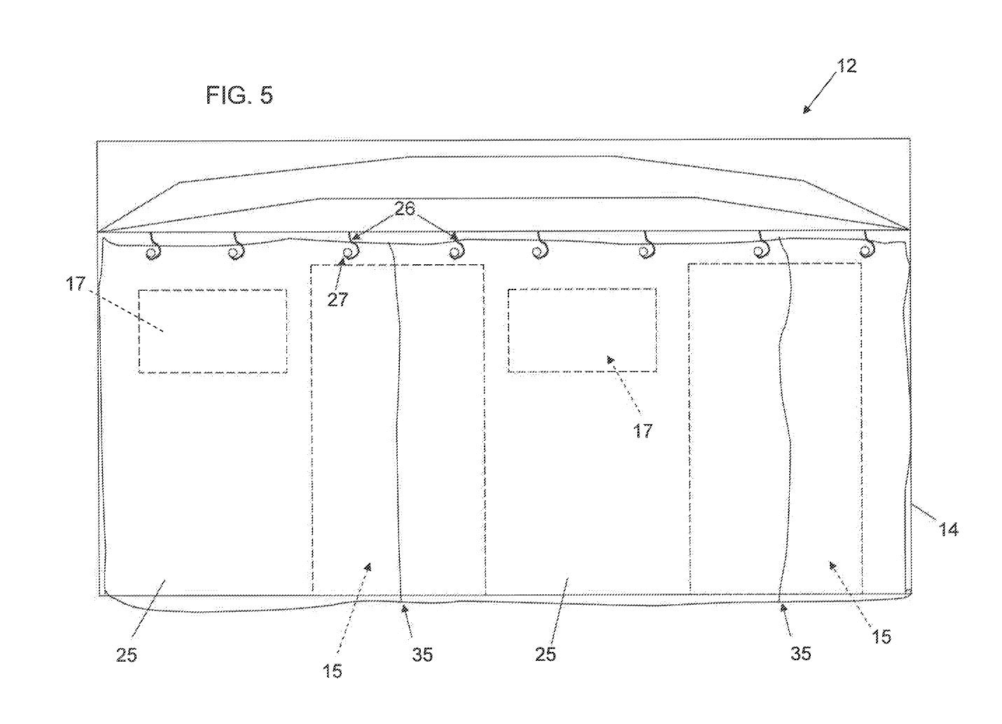

FIG. 5 shows a front view of the interior wall of a shelter as provided in accordance with one embodiment of the present invention. As shown therein, one or more wall blankets, attachments or panels 25 are positioned and secured in place along the wall member 14 of the shelter 12 in accordance with one aspect of the present invention. Each panel can be rigid or non-rigid and can be formed using soft or hard armor material to withstand bullets, small arms fire, personnel ammunitions, fragmentation from explosions, or other known forms of penetrating and potentially lethal objects (hereinafter “projectiles”). In one embodiment, the panel includes an outer shell of heavy-duty nylon which can contain a ballistic insert packet made of plies of appropriate ballistic material, woven or non-woven. The insert packet in this embodiment can be any ultra high molecular weight polyethylene based fiber having an appropriately high strength to weight ratio and an appropriately low specific gravity so as to meet threat level standards. Spectra™ and Dyneema™ materials may be employed in one embodiment, as well as aramid materials such as Kevlar™ and Twaron™, for example. The insert packet can also be made of a para-aramid fiber a woven or non-woven form that possesses high tensile strength, cut and flame resistance and high chemical resistance. It will be appreciated that the outer shell can be provided of various types of materials depending upon the particular deployment requirements (e.g., waterproof, fire retardant, etc.).

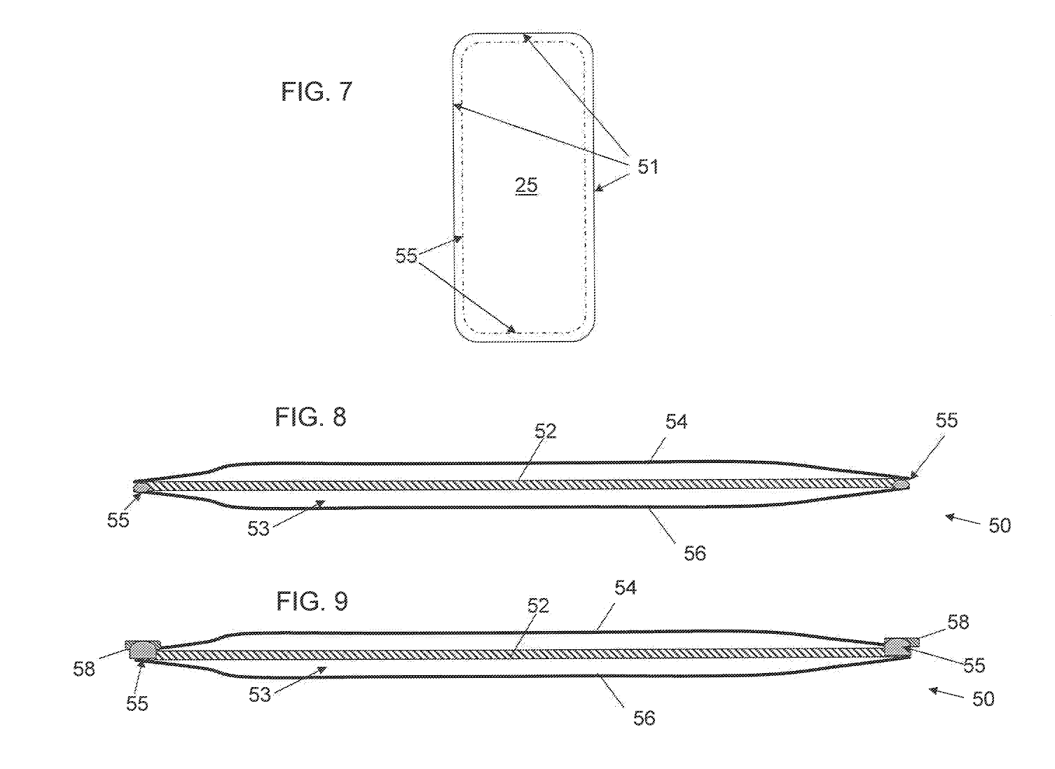

FIG. 7 illustrates an embodiment of the wall attachment 25 of the present invention with a seam 55 along the outer perimeter 51 thereof, In one embodiment of the present invention, the seam 55 acts to seal two plies of an outer shell material of the wall attachment around the insert packet so as to encapsulate it therein. The seam can be provided by sewing, or in one embodiment of the present invention, the seam is provided by welding using an impulse welder, for example. As illustrated in FIG. 8, for example, the outer shell 50 can be welded with the insert packet 52 between the plies 54, 56 of the outer shell and forming part of the seam 55, such that the outer shell 50 and the insert packet 52 are joined together. The insert packet 52 resides in a pocket or opening 53 created between the outer plies 54, 56 of the outer shell of the wall attachment. In this embodiment of the present invention, the insert packet is not only encapsulated within the outer shell, but is also held in place along its external perimeter, to thereby prevent shifting, sliding, sinking, sagging and/or other undesirable movement within the outer shell. Such movement of the insert packet is undesirable because it can reduce the anti-ballistic coverage of the present invention. In a further embodiment of the present invention, as shown in FIG. 9, the welding of the seam 55 of the outer shell 50 can also include the welding of an external strip of material 58 (e.g., fabric) that can be provided with attachment mechanisms (not shown), such as hook or loop fasteners, grommets, hooks, clasps, or similar articles. These attachment mechanisms can be used to attach one panel to another and are provided or secured on the material 58 in accordance with known methods in the art. Thus, as part of the present invention, a single welded seam 55 can join the outer plies 54, 56 of the outer shell 50, the ballistic insert packet 52 and the attachment mechanism strip 58, In one embodiment of the present invention, the ballistic panel 52 is sewn to a heat seal fabric not shown) before being welded to the outer shell plies.

As further shown in FIG. 5, the arrangement of panels can also accommodate entry and exit components of the existing tent or structure, and can further accommodate windows or other openings in the tent or structure. Thus, for example, if there is a door 15 in a doorway or entryway provided as part of the existing shelter, the panels can be arranged such that two adjacent panels overlie one another at or around the entry way, as shown by arrow 35. In such embodiment, a person desiring to enter or leave the tent can pull back or push away one of the panels and slip through the entry way. Each panel member can have the specific dimension of approximately 88 inches by approximately 110 inches, although the precise dimensions will depend upon the shelter type and the implementation involved in the deployment. In this way, the shelter of the present invention can be utilized as if the ballistics were not in the shelter. While any windows 17 will be covered in the preferred embodiment of the invention, the windows can still be opened if necessary to allow ventilation.

As further shown in FIG. 5, wall panel 14 can be provided with attachment means such as grommets or eyelets 27 integrally formed into the panel such that the grommets can be placed over and around hooks 26 or similar items provided on a tent frame or external frame so as to depend downwardly and outwardly therefrom. The tent frame (whether as part of the existing tent or as provided separately) can be provided with a cable secured thereto for receiving the hook members. In one embodiment of the present invention, the hooks are held stationary by the cable member. In another embodiment, the hooks are slidable back and forth along a horizontal cable secured to the frame in such a way that the hooks can be easily moved to the location most accessible to the panel grommets.

Alternatively, the wall panel members can be secured to the shelter or shelter frame using attachment means such as a hook and loop connector, a zipper or a snap member, for example. In the embodiment incorporating a zipper, a first zipper edge or taper can be provided on the wall panel member and a second zipper edge or taper can be provided on the shelter wall or frame. Because of the non-rigid nature of the wall panel, once it is secured to the tent frame, it is collapsible along the provided wall of the tent or shelter, in the sense that the panel rests alongside the wail and does not extend obtrusively therefrom, as shown in FIG. 4, for example.

In one embodiment of the invention, the panel can be provided with side attachment elements for securing to a separate panel in side-by-side format such that little or no space exists between the respective sides of the panels. Such arrangement can be through attachment mechanisms similar to that described for securing a panel to a structure frame as noted above. In one embodiment of the present invention, panels are placed and secured side by side with an overlap of for example, four to six inches. In one embodiment, adjacent panels are integrally formed as a single unit. In another embodiment, the adjacent panels are integrally formed with a permanent hinge type member or are sewn or otherwise attached so as to allow either the front faces or the back faces of the panels to be mated upon hinging to assist in ease of transport, as well as breakdown and setup of the wall structure. The overlap formation can limit the ability of a projectile penetrating the seam of the two panels.

The present invention can also accommodate corners within tents or structures. A corner element may be configured to adhere or otherwise attach to the wall panel elements so as to protect any corners that may not otherwise be sealed using the panels described above. Such a corner member may be smaller in width, but of the same length so as to provide a full length barrier to any projectile that might otherwise be capable of penetrating a corner where two adjacent panels are not sufficiently overlapping. The corner member can also be provided with attachment means such as those described above for securely mating with appropriate receiving means of the tent or structure frame. In one embodiment, the side wall non-rigid panel can be bent and attached to the end panel to create sufficient overlap and protection.

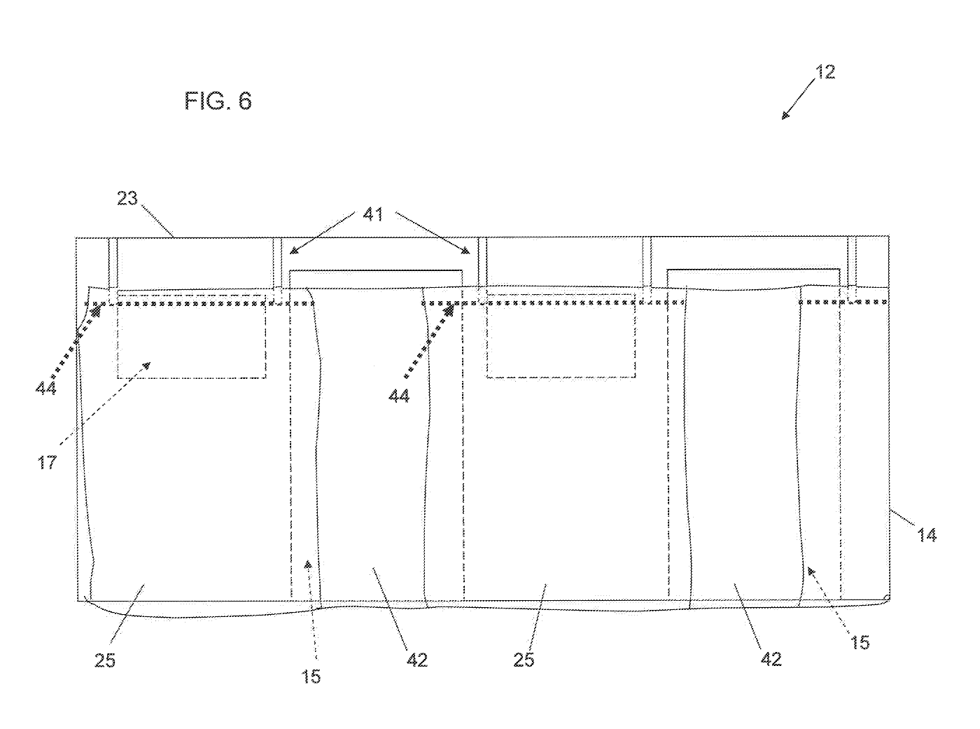

FIG. 6 shows a front view of the interior wall of a shelter as provided in accordance with another embodiment of the present invention. As shown in FIG. 6, a securing pole member 44 made of metal, plastic or other suitable material can be secured to a top portion of the panel members 25 such as by straps or other suitable means on the exterior of the panels, or by folding over a top portion of the panel member and stitching a seam substantially horizontally along the panel member so as to form an opening through which the pole member can be threaded. The pole member 44 can act as an anchoring point for securing straps, cords or other drawstring-type members 41 which can be used to raise and lower the panel members up and down the wall 14. The straps 41 can be nylon or other suitable material and can he secured at one end to a top shelter frame member 23 and at the other end to the pole member 44, in one embodiment of the present invention, the straps 41 are secured at a first end by hook and loop-type fasteners (or similar fasteners as described) to the pole member 44 of a corresponding panel 25, and then positioned around an upper, substantially horizontal frame member 23 with the other end of the strap being secured to the pole member 44 or the panel member 25 itself using hook and loop type fasteners or similar fasteners. In this way, one end of the strap members 41 can be disconnected from the pole or panel member so that the user can pull the strap member and thereby the panel member can be moved further up or down the shelter wall. As such, the present invention allows for adjusting the height of the ballistic panel member(s) on the wall,

In the embodiment shown in FIG. 6, an overlap panel member 42 is provided in between two panel members 25 around a door opening 15, and the overlap panel member 42 is not provided with a pole member or straps secured thereto. Rather, overlap panel member can be secured to the panel members 25 by sewing, hook and loop fastener or similar fastening means. In one embodiment of the present invention, overlap panel member is sewn to a first panel member, and then connected via hook and loop fastener to a second panel member adjacent the first panel member. In this way, the hook and loop-type fastener can be easily detached while the sewn connection of the overlap panel to the first panel member restricts the detachability. Thus, the overlap panel member can possibly pivot around the sewn seam as a door would pivot, thereby allowing a user easier entry and exit through a door 15 in the structure.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A wall attachment for a tent or portable shelter, comprising:
an outer shell comprising two plies of material having an outer perimeter, wherein the two plies of material are welded together so as to form a welded seam along the outer perimeter thereof and so as to form an interior pocket; and
a ballistic insert packet positioned within the interior pocket and welded between the two plies of the wall attachment.

2. The attachment of claim 1 wherein the wall attachment includes an external strip of material welded to the welded seam, wherein the external strip is provided with at least one attachment mechanism.

3. The attachment of claim 1 wherein the insert packet is further sewn to a heat seal fabric.

4. A method for providing a wall attachment, comprising the steps of:
providing at least two plies of outer shell material, each having an outer perimeter;
providing a ballistic insert packet with an outer perimeter;
welding the ballistic insert packet in between the at least two plies of outer shell material so as to form a welded seam along the outer perimeter thereof and so as to retain the insert packet within the two plies of outer shell material.

5. The method of claim 4, wherein the welding step includes welding an external strip of material to the outside of one of the plies of outer shell material, wherein the external strip includes at least one attachment mechanism.

6. The method of claim 4, wherein the insert packet is sewn to a heat seal fabric prior to being welded in between the at least two plies of outer shell material.

7. An integrated ballistic shelter, comprising:
a portable fabric element;
a primary frame for supporting the portable fabric element such that said fabric element is capable of providing at least one wall covering openings in said frame so as to define a shelter interior having outer edges; and
at least one wall attachment secured to the primary frame and maintained along or near the outer edges of the shelter interior, wherein the at least one wall attachment is separate and apart from the at least one walk wherein the wall attachment comprises an outer shell comprising two plies of material having an outer perimeter, wherein the two plies of material are welded together so as to form a welded seam along the outer perimeter thereof and so as to form an interior pocket, and wherein the wall attachment further comprises a ballistic insert packet positioned within the interior pocket.

8. The shelter of claim 7 wherein the insert packet of the wall attachment is welded between the two plies of the wall attachment.

9. The shelter of claim 7 wherein the wall attachment includes an external strip of material welded to the welded seam, wherein the external strip is provided with at least one attachment mechanism.

10. The shelter of claim 7 wherein the insert packet of the wall attachment is further sewn to a heat seal fabric.
